(19) United States
(12) Patent Application Publication
(10) Pub. No.: US 2014/0067836 A1
(43) Pub. Date: Mar. 6, 2014

(54) VISUALIZING REPORTING DATA USING SYSTEM MODELS

(71) Applicants: Ta'id Holmes, Maintal (DE); Andreas Roth, Walzbachtal (DE); Anis Charfi, Darmstadt (DE); Heiko Witteborg, Griesheim (DE)

(72) Inventors: Ta'id Holmes, Maintal (DE); Andreas Roth, Walzbachtal (DE); Anis Charfi, Darmstadt (DE); Heiko Witteborg, Griesheim (DE)

(73) Assignee: SAP AG, Walldorf (DE)

(21) Appl. No.: 13/605,376

(22) Filed: Sep. 6, 2012

(51) Int. Cl. G06F 17/30

(52) U.S. Cl. 707/756; 707/E17.005

(57) ABSTRACT

Methods, computer-readable media, and computer systems for visualizing reporting data using system models. Reporting data from multiple data sources is extracted and mapped to a common language reporting. The mapped reporting data is correlated to elements of system models. Visualization options to present the mapped reporting data correlated to the system models are identified. The mapped reporting data is presented according to the visualization options in response to receiving a request for reporting data.

### TECHNICAL FIELD

The present disclosure relates to software, computer systems, and computer-implemented methods for presenting data.

### BACKGROUND

The collection, preparation, and presentation of runtime information from business applications and enterprise systems can be useful to users who review and analyze these data. Models, which are usually used for the design of computing systems, can be specified and represented at different abstraction levels making it easier for users to relate to the concepts. Often, however, model-driven systems are unrelated to the models from which they have been generated. Consequently, a synchronization with design models of model-driven enterprise systems and business applications can be cumbersome. If models can be related during the lifecycle of a business application, then the models from runtime may be useable for reporting.

### SUMMARY

The present disclosure involves systems, software, and computer-implemented methods for visualizing reporting data using system models.

In general, one innovative aspect of the subject matter described here can be implemented by data processing apparatus to visualize reporting data using system models. Reporting data is extracted from multiple data sources. Each data source is configured to store at least a portion of the reporting data. The extracted reporting data is mapped to a common language for reporting. The mapped reporting data is correlated to elements of system models. Visualization options to present the mapped reporting data correlated to the system models are identified. The mapped reporting data is presented according to the visualization options in response to receiving a request for reporting data.

This, and other aspects, can include one or more of the following features. Presenting the mapped reporting data according to the visualization options can include creating annotations using contained styles and content, including the created annotations in a process system model, and displaying the annotations in a user interface of a display device. Correlating the mapped reporting data to elements of system models results can provide abstract annotations of the elements of the system models. The abstract annotations can be transformed into concrete model annotations. The common language can be a domain-specific language that is executable to select runtime information from execution instances, combine the selected runtime information with a model for the model-based reporting, and specify a visualization of the model-based reporting. The domain-specific language can include a model selection part to select a model for the model-based reporting, an instance selection part for selecting instances of runtime executions, an abstract annotation part to assign reporting data to elements of system models, and a formatting part to display the mapped reporting data graphically. Correlating the mapped reporting data to elements of system models can include generating multiple execution points that correspond to multiple elements of system models. Each execution point can be uniquely identifiable. The mapped reporting data can include data produced by a business application through at least one of events or stored log messages. The mapped reporting data can be processed by business analytics. Extracting the mapped reporting data can include monitoring the mapped reporting data either online through events or offline through log messages.

Another innovative aspect of the subject matter described here can be implemented as a non-transitory computer-readable medium storing computer instructions executable by data processing apparatus to perform the operations described here. A further innovative aspect of the subject matter described here can be implemented as a system including data processing apparatus and a computer-readable medium storing computer instructions executable by the data processing apparatus to perform the operations described here.

While generally described as computer-implemented software embodied on tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features and advantages of the disclosure will be apparent from the description and drawings, and from the claims.

### BRIEF DESCRIPTION OF THE DRAWINGS

FIG. 1 illustrates an example of a system architecture for model-based reporting.

FIG. 2 illustrates an example of a reporting architecture of a model-driven business application for model-based reporting.

FIG. 3 illustrates the example reporting architecture of FIG. 2 in more detail.

FIG. 4 illustrates an example system for model-based reporting including a frontend, a backend, and a data warehouse with reporting data.

FIG. 5 illustrates an example of a reporting data metamodel.

FIG. 6 illustrates an example of a runtime context data metamodel.

FIG. 7 illustrates an example of an abstract-annotations metamodel.

FIG. 8 illustrates an example of a model-based reporting model annotations metamodel.

FIG. 9 illustrates an example of a formatting metamodel.

FIG. 10 illustrates an example of a model-based report that displays model-annotations in a process model.

FIG. 11 is a flowchart of a process for visualizing reporting data using system models.

Like reference numbers and designations in the various drawings indicate like elements.

### DETAILED DESCRIPTION

This specification describes computer-implemented methods, computer-readable media, and computer systems for visualizing reporting data—for example, runtime data, analytics data—of a system using models that describe the system's architecture and design. Business process flows can be modeled by introducing a level of abstraction that is removed from the details of implementation. For example, by recognizing that a process flow in a business can have many implementations in which the data and the fundamental process flows are often substantially similar, the same modeling object (i.e., the process component) can be used for the same business process flow. The data for each process flow can be modeled using business objects. In such model-driven engineering (MDE), models are designated roles from which systems are generated. MDE can enable different users of a business application to participate in the engineering process. The techniques described in this disclosure enable the use of MDE in phases beyond code generation and deployment, for example, in the monitoring, analysis, and reporting phases.

The techniques, referred to, in some implementations, as “Model-based Reporting” (MbR) can extend the scope of MDE to phases beyond code generation and can link the execution, monitoring, analysis and reporting with system models. In addition, MbR bridges the gap between execution and design, can enable users to intuitively specify the reporting through a domain-specific language (DSL) and to visualize reporting data in system models. MbR can be applicable in settings in which there is no clear demarcation between design-time and run-time of a system, for example, in cloud-based on-demand computer systems in which the computer software provisioning as a service can enable easy and fast re-deployment. In such systems, the mapping between operations, events, and design artifacts can be automated using the MbR approach allowing for rapid cycles between observing system behavior and reacting to the behavior by modifying the system.

In some implementations of the MbR approach, reporting data is extracted from data sources. For example, different types of reporting data can be extracted from different sources. The extraction can include the definition of further processing of runtime data such as performing calculations or aggregating data to produce the reporting data. The reporting data can be mapped to a common language for model-based reporting to allow a common and platform-independent representation for the extracted reporting data although the data originates from heterogeneous sources.

The reporting data can be correlated to elements of systems models by the DSL language for selecting reporting data possibly from multiple execution instances and correlating the selected data to elements of the modeling language in which the system models are defined. For example, when a business process is used, certain execution events can be associated with specific activities in the business process model. The DSL can be independent from products, platforms, and technologies, and can be extensible in several regards, such as with respect to reporting data types and formatting concepts. The correlation can be used by the matching component to associate reporting data with elements of the system models.

Visualization options to configure the presentation of the runtime data can be represented in the graphical model using the DSL. For example, a user interface (described later) can be generated and displayed to include shapes that represent execution time of process activities. Other representation options of connections or nodes of the business process models can be defined. Certain graphical icons can be displayed on the elements of the graphical model when an incident or an error occurs at runtime. To visualize the reporting data in system models, runtime data can be displayed in a graphical and intuitive manner based on system models. The visualizations can be generated by the Model Annotator component (described below).

Implementing the MbR approach and the techniques described in this specification can provide one or more of the following advantages. The MbR approach can be generic in that it can be applicable to graphical modeling languages (for example, Business Process Modeling Notation, Unified Modeling Language). The approach can also be generic with respect to the type of reporting data that can be displayed (for example, usage data, performance data, incident data, and the like). The approach can be used with computer systems in general without needing to be bound to a particular domain (for example, business applications, real time systems, embedded systems, and the like). In sum, the MbR approach can be applied to any system model and in settings in which models are introduced at a later phase.

Further, by relating information from runtime and analytics with models at reporting time, MbR can bridge phases of the business application engineering life cycle, for example, by enabling stakeholders to consume the reporting data while relating to models. In an MDE context, the models can be design time artifacts. Users can use the MbRs as a starting point for modifying and evolving model-driven business applications, thereby shortening development cycles.

Moreover, the approach can offer a unified environment for business application engineering. An integrated development environment (IDE) can be adopted as a frontend for different phases of a business application lifecycle, i.e., as a modeling or reporting tool. This can provide for a consistent environment to developers and other users of business applications. In an MDE context, the MbR frontend can be integrated into the modeling tools. Models that are used for MbR can then be revised directly for a new iterative development cycle. The generic and conceptual approach of MbR enables adopting the approach in different, diverse products. MbR tools can be decoupled from business intelligence and can potentially be utilized with different products, platforms, and technologies. Decoupling the reporting from the business intelligence can ease interoperability of tools that perform various operations.

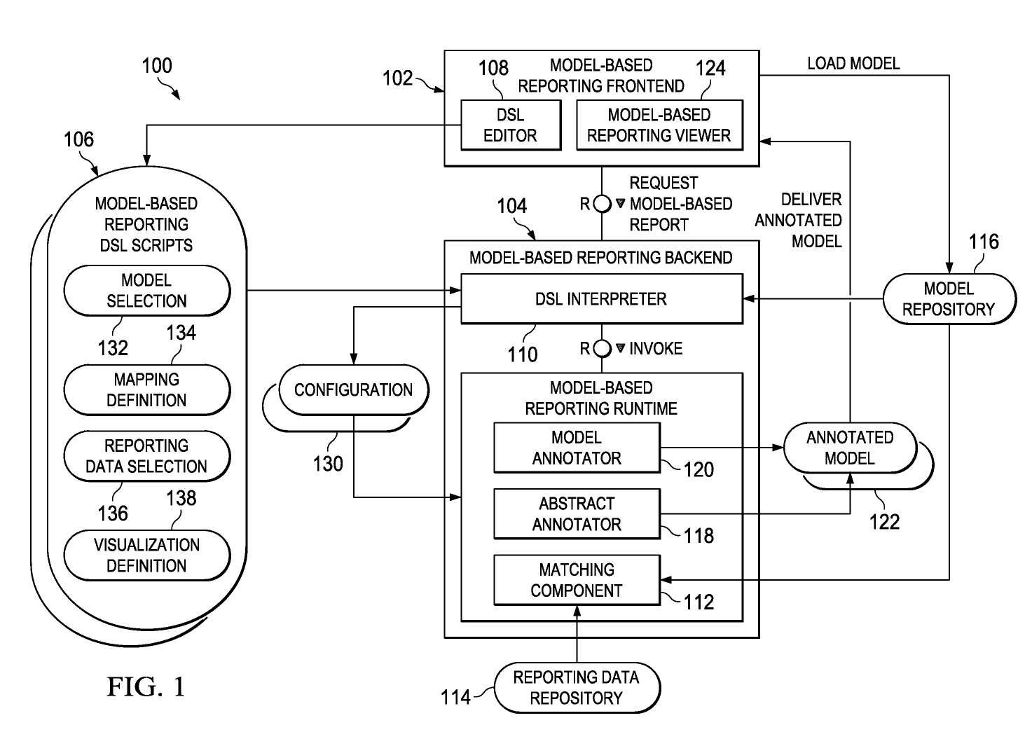

FIG. 1 illustrates an example of a system architecture 100 for model-based reporting. The system 100 can include an MbR frontend component 102 and an MbR backend component 104. The frontend component 102 and the backend component 104 can be de-coupled, in some implementations, in heterogeneous environments. For example, the system 100 can be configured for an application, such as visualizing execution time in business process models. MbR systems can alternatively be implemented in distributed systems. An MbR DSL script 106 can be defined using a DSL editor 108. The script 106 can define system models that are relevant, reporting data that is relevant, a correlation between reporting data and model elements of the system models, and visualization options. The system 100 can include a DSL interpreter 110, which is a component of the MbR Backend component 104. The DSL interpreter 110 can generate a configuration from the DSL script, for example, an SQL procedure.

At runtime, a matching component 112 can use the configuration of the system 100 to match the reporting data, retrieved from a reporting data repository 114, to elements of a system model (retrieved from a model repository 116. An abstract annotator 118 can enrich the system model with abstract annotations that can define the relevant reporting data. A model annotator 120 can then enrich the model generated by the abstract annotator 118 with concrete annotations, which can define the visualization options. The annotated model 122 can then be sent to an MbR Viewer 124 for display. In some implementations, the MbR Viewer 124 can be integrated in an environment in which a developer of a system works with the model, for example, a model editor in an integrated development environment (IDE).

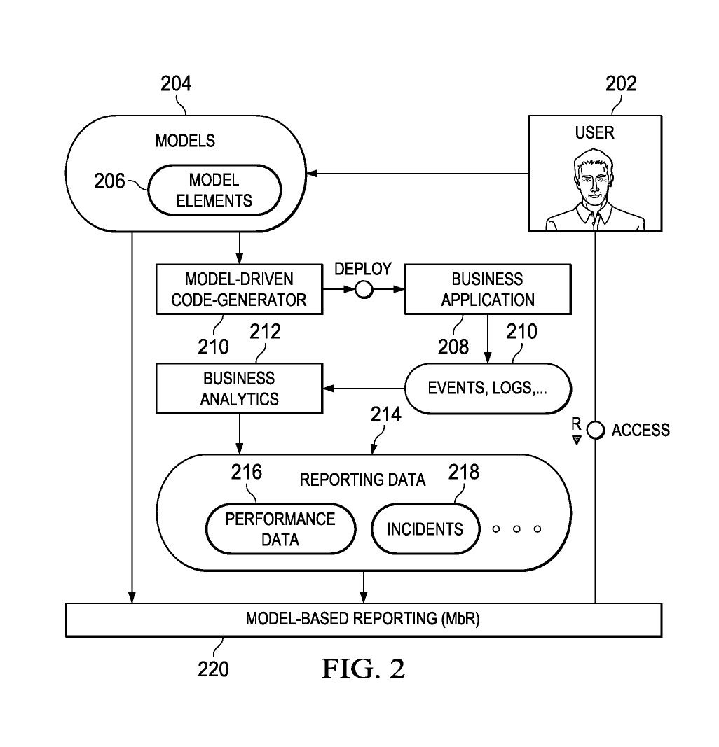

FIG. 2 illustrates an example of a reporting architecture of a model-driven business application for model-based reporting. MbR can be implemented in the context of business applications. As described above, business applications can be described in terms of models, generated through model-to-code transformations, and deployed to a destination platform in MDE settings. At runtime, information can be provided to a business intelligence and stored in a data warehouse for reporting. The MbR approach can connect and reconnect reporting data from systems with models and model elements that reflect these systems. To do so, MbR can implement data reporting from the monitoring and runtime based on design-time models.

FIG. 2 shows a user 202 (for example, a business application developer) who can be a stakeholder of a business application storing models containing model elements 206 in a model repository 204. A model-driven code generator 210 can generate and deploy a business application 208. During execution, the model-driven code generator 210 can produce runtime information that is emitted via events 211 or stored in log messages which can be processed by business analytics 212 to provide reporting data 214. The reporting data 214 can include the basis for reporting and can span multiple categories including performance (performance data 216), usage, or incidents 218, which can include exceptions from and violations of the business application. The MbR module 220 can receive input from the models 204, the user 202, and the reporting data 214 to generate visualizations of the data.

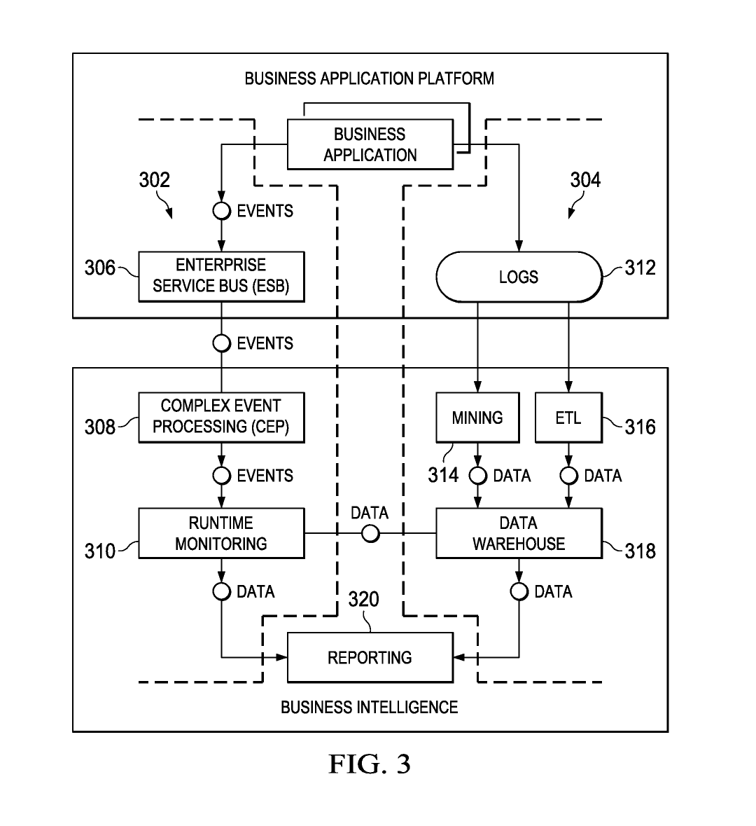

FIG. 3 illustrates the example reporting architecture of FIG. 2 in more detail. In some implementations, an architecture for business applications in regard to a business intelligence can be implemented in two parts—an online analysis part 302 and an offline analysis part 304. The system 100 can implement the online analysis part 302 (shown on the left in FIG. 3) by monitoring events using an enterprise service bus (ESB) 306, complex event processing module (CEP) 308, and a runtime monitoring module 310. The system 100 can implement the offline analysis part 304 (shown on the right in FIG. 3) by monitoring log messages 312 (or logs). The two parts need not depend on each other, but can be implemented independently to obtain results for a subsequent reporting. Results from business analysis can be obtained using the mining module 314 or the extract, transform, and load (ETL) module (or combinations of them). Data transformations can be stored in a data warehouse 318 that is utilized by the reporting module 320 to generate the reports.

The system 100 can implement MbR by building on a business intelligence, for example, from the business analytics of the business intelligence. The system 100 can provide users (for example, user 202) with data, such as relevant calculated data and metrics such as key performance indicators (KPIs). To do so, the system 100 can use information received from any data source, for example, a business intelligence or any other system. In some implementations, the system 100 can establish a correlation between information (for example, data) received from any source, such as a business intelligence or a system directly) with models and model elements. The system 100 can establish the correlation through a dynamic resolution providing flexibility. In other words, for a given model element (i.e., a respective point in execution), the system 100 can implement a correlation service that can return a set of execution points (i.e., corresponding model elements). Table 1 below lists operations of a correlation service for managing correlation entries in the data warehouse.

TABLE 1
Correlation Service

| Return Type | Operation | Parameter |
|---|---|---|
| executionID[ ] | getEIDs | modelElementID |
| modelElementID[ ] | getMIDs | executionID |
| Boolean | register | executionID, modelElementID |
| Boolean | unregister | executionID, modelElementID |

In some implementations, execution points within the business application can be uniquely identifiable by an executionID. The runtime environment internally can provide traceability; yet, executionIDs can be provided outside of execution for the correlation to model elements. An instanceID can track an execution instance. A business application can disclose traceability information when emitting events, sending or writing log messages or database entries so that these identifiers can be determined and supplied to the reporting. The system 100 can include an MbR service (described below) which can be integrated into the business intelligence to relate the information from the runtime to the models using the correlation entries.

In some implementations, the unique identification may not take the form of a Universally Unique Identifier (UUID). Rather, the unique identification can be established in business applications with business relevant records and documents that can be related, for example, to suppliers, vendors, customers, and the like. In implementations in which the system 100 can reconstruct built-in processes, the system 100 can establish correlation with models for execution points. The system 100 can instruct model drive business applications automatically with such identifiers and can vary the granularity of instructions. Also, the system 100 can generate correlation entries for the models and model elements. The system 100 can also register model elements. This can be particularly useful when new models provide additional views on the system. The system 100 can then utilize these models for view-based model-based reporting.

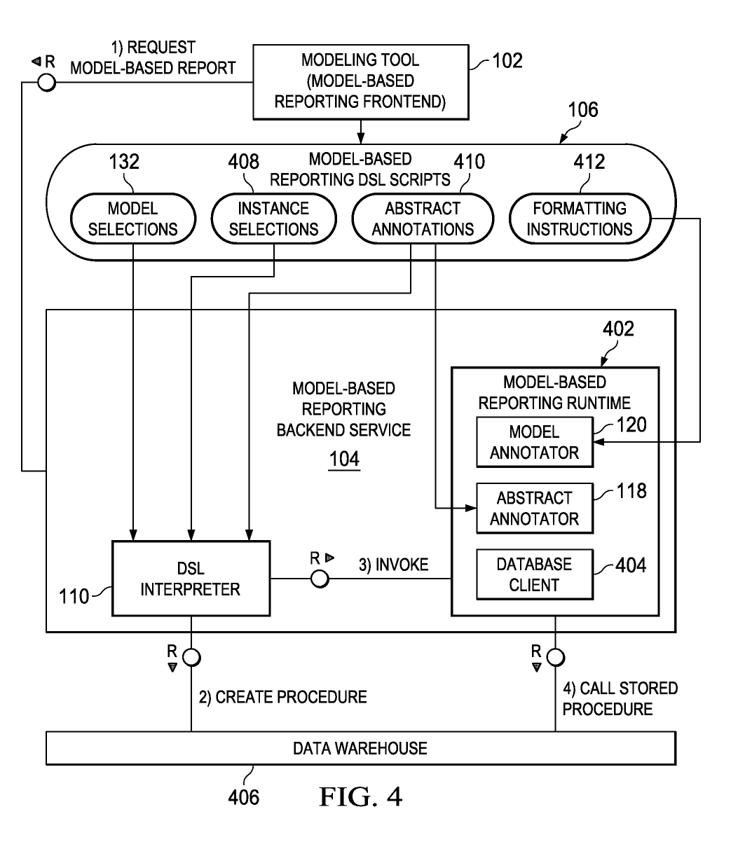

FIG. 4 illustrates an example system for model-based reporting including a frontend, a backend, and a data warehouse with reporting data. Each component of the architecture shown in FIG. 4 can be implemented as computer software modules, i.e., computer instructions stored on computer-readable media and executable by data processing apparatus to perform operations. The system 100 that implements the architectural overview illustrated in FIG. 4 includes a metamodel (described below) for reporting data, a DSL for specifying the reporting, and a backend service. The modeling tool (i.e., the MbR frontend 102) can invoke the service with a MbR DSL script 106 which includes the model selection module 132, an instance selection module 408, an abstract annotation module 410, and formatting instructions 412. The system 100 includes an MbR runtime module 402 that includes a model annotator 102, an abstract annotator 118, and a database client 404. The MbR runtime module 402 processes the DSL script 106 and retrieves reporting data and associates the data with model elements. The system 100 transforms the abstract annotations of model elements into concrete model annotations for the MbR frontend 102.

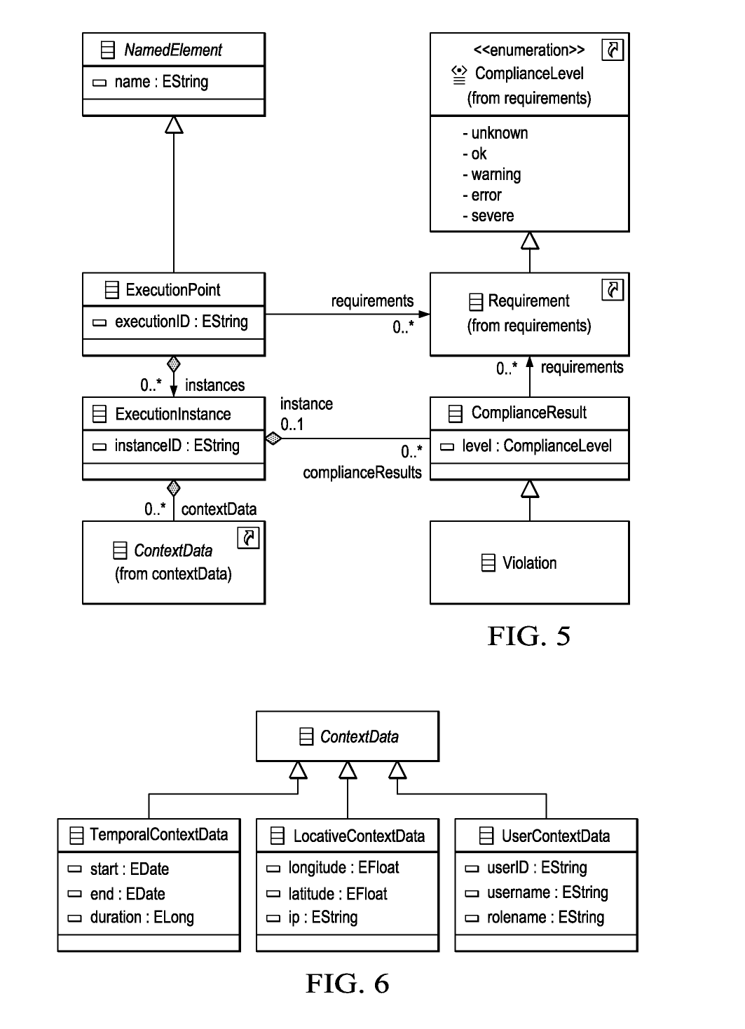

FIG. 5 illustrates an example of a reporting data metamodel. The reporting metamodel includes the concepts of ExecutionPoint and ExecutionInstance containing executionID and instanceID properties, respectively. In the reporting metamodel, runtime information is generically captured as ContextData. In selection and evaluation expressions, the MbR DSL relates to reporting data as residing in the data warehouse 406. To facilitate queries and for raising the abstraction to a technology and platform independent level, the system 100 can implement a reporting metamodel that describes the data for the reporting. From this customizable and extensible metamodel, the system 100 can generate the database for the MbR in the data warehouse 406. The model-driven reporting database can be a target of business analytics applications that populate it with reporting data.

FIG. 6 illustrates an example of a runtime context data metamodel that includes dimensions such as temporal, locative, and user context data. In addition to these dimensions, the runtime context metamodel can include concepts such as Requirements and ComplianceResults with Violations. In some implementations, ExecutionPoints can be associated with requirements from requirements engineering (RE) and compliance results such as violations that occur during runtime as evaluated and identified by monitoring are related to ExecutionInstances for model-based reporting. Addressing business application compliance, the system 100 can implement MbR to utilize compliance relevant data as first-class entities and, for example, highlight violations in reports.

The system 100 can relate the DSL to the reporting data using query expressions according to the metamodel. In this manner, the system 100 can consider the metamodel for code completion and syntax checking. In addition to the names of classes and properties as found in the metamodel, the system 100 can use alias names for brevity in the DSL. The system 100 can implement the MbR service to transform the high-level and platform independent query expressions to low-level and technology specific Structured Query Language (SQL).

The MbR DSL enriches models and model-elements with runtime information. The MbR DSL can enable users to specify the reporting in a tailored manner. The language comprises features to select runtime information from execution instances, combine them with the model for the model-based reporting, and specify the visualization of the reported data. A MbR DSL script can include multiple parts, for example, four parts, described below. The listing below shows an example syntax of the MbR DSL:

| | |
|---|---|
| 1 | MbRscript = |
| 2 | {ModelAssignment} |
| 3 | {InstanceSetAssignment} |
| 4 | {Annotation} |
| 5 | {Formatting}; |

The first part of the syntax is a syntax of model selection. An example syntax of model selection is shown below:

1 ModelAssignment =
2 ModelVariable ‘:’ Model;

The model selection serves to select a model for the MbR and thus to define its context. For this, a unique identifier such as a UUID of the model can be used. If models have been assigned names and if these names are unique across all models, the name of the model can also be used for the selection thereby contributing to the readability of the script.

The next part of the syntax is an instance selection. Once the context has been defined with a model for the reporting, instances of runtime execution are selected in the second part of the MbR DSL. An example syntax of an instance selection is shown below:

1 InstanceSetAsignment =
2 InstanceSetVariable ‘:’
3 InstanceSelectExpression;

To select instances of runtime executions, sets of execution instances can be specified using queries. For example, a set containing a single instance can be specified using its instanceID. The sets can then be used for the abstract annotations.

The subsequent part of the DSL is an abstract annotation, an example syntax of which is shown below:

1 Annotation =
2 ModelElementSetSelectExpression {
3 ‘<<’ AnotationKey
4 ‘=’ EvaluationExpression};

The abstract annotation part of the DSL assigns reporting data to model elements. This way, the model is enriched with data from the runtime and analytics. The abstract annotations can be supplemented by the formatting instructions at the end of the script to concretize the visualization. For the annotation, model elements can be selected, for example, by name, type, or UUID. Each model element can be associated with results from an operation via a respective annotation key name.

A following part of the DSL is a formatting instructions part, an example syntax of which is shown below:

| | |
|---|---|
| 1 | Formatting = |
| 2 | AnnotationKeyName |
| 3 | [{‘,’ AnotationKeyName}] ‘>>’ |
| 4 | AnotationElementCreateExpression ‘{‘ |
| 5 | [{ElementStyleExpression}] |
| 6 | ‘}{‘ |
| 7 | [{ContentStyleExpression}] |
| 8 | ‘{’; |
| 9 | |
| 10 | AnnotationKeyName = |
| 11 | AnnotationKey [‘{‘ AnotationName ‘}’]; |
| 12 | |
| 13 | StyleExpression = |
| 14 | StylePropertyName ‘:’ |
| 15 | StyleExpression ‘;’; |

The formatting instructions part of the DSL specifies how the abstract annotations should be displayed graphically for visualization. To do so, the annotation key can be used and an annotation element for presentation can be created. The element and the annotation content can then be assigned formatting styles. Style properties can be assigned values that can depend on content of the annotation. This can be useful for case-based visual presentation of reporting data. For example, values can be compared against thresholds and depending on the result, the data can be highlighted or not shown at all.

The MbR Backend Service 104 (described below) is invoked by the MbR Frontend 102 and, in response, delivers a model-based report for visualization. The MbR Backend Service 104 includes a DSL interpreter 110 that processes the MbR Script. In some implementations, from the model selection part, instance selection part, and abstract annotation part of the MbR script, the DSL interpreter 110 can generate a SQL procure that is called later by the MbR Runtime 402. The DSL interpreter 110 can create the procedure at the data warehouse 406 and invoke the MbR Runtime 402. In other words, for each model element of the model reporting data, the DSL interpreter 110 can look up the executionIDs. Also, the DSL interpreter 110 can relate the type of information—either used in queries of the second part or in expressions of the third part of the DSL script—to the reporting tables.

After the SQL procedure has been created as a preliminary action, the MbR Runtime 402 can realize the model-based reporting using the following modules. The MbR Runtime 402 can include a database client 404 which can retrieve reporting data for the model-based reporting from the data warehouse. For this, the MbR Runtime 402 can call the stored procedure and transform its results if necessary.

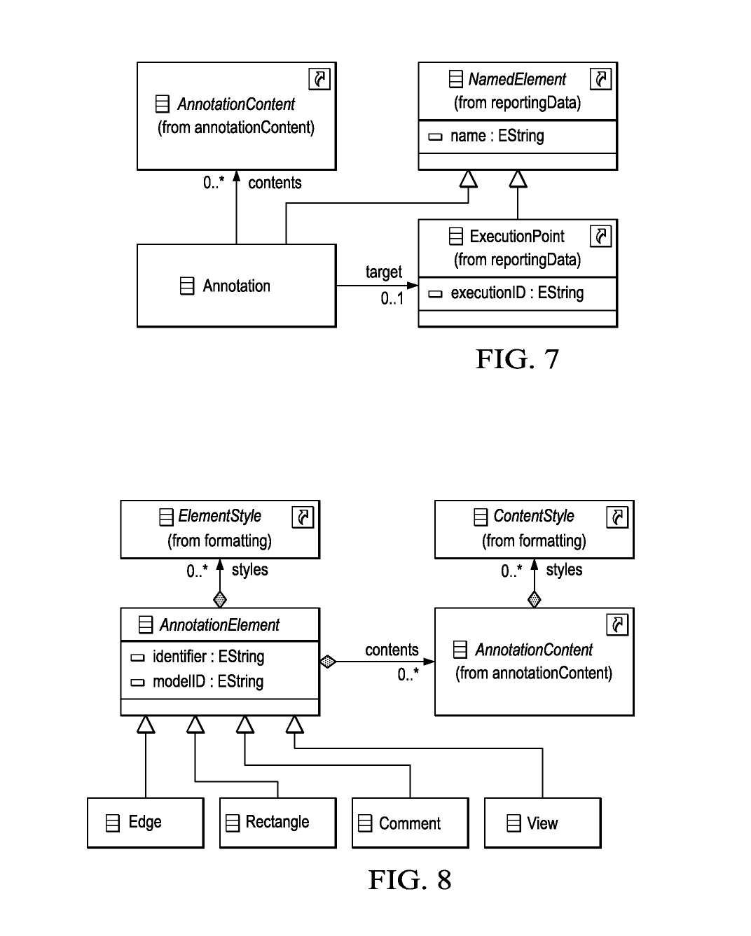

The MbR Backend Service 104 then annotates the data according to the third part of the MbR script. FIG. 7 illustrates an example of an abstract-annotations metamodel that the abstract annotator 118 produces. In the model, the Annotations relate to ExecutionPoints, not model elements. Thus, at this step, the MbR Backend Service 104 evaluates the correlation of model elements and execution points.

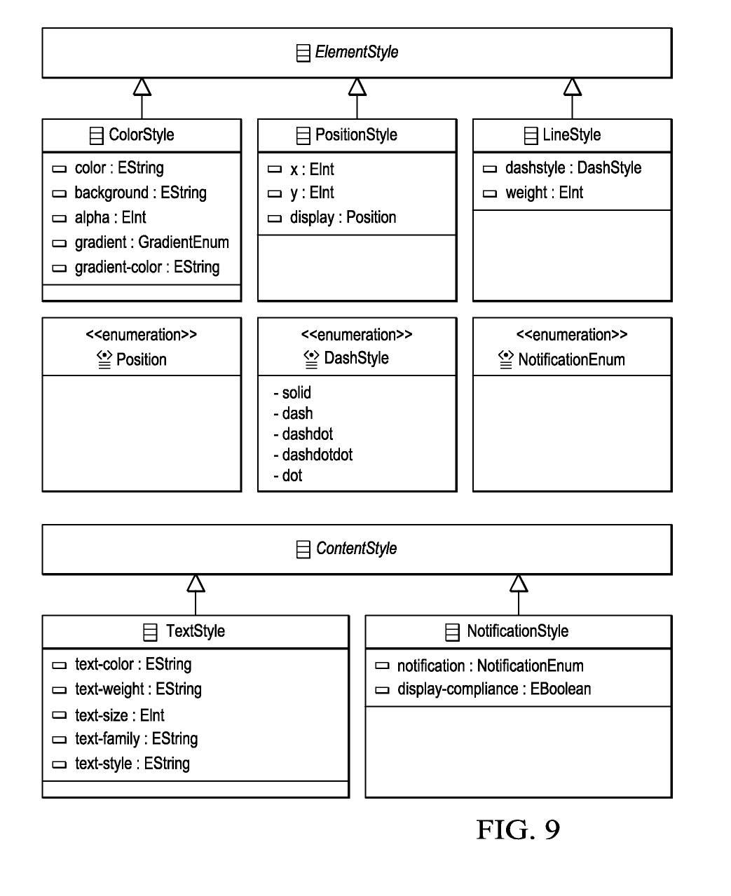

The MbR Backend Service 104 then transforms the abstract annotations to the final format via a model transformation according to the fourth part of the MbR script. To do so, the MbR Backend Service 104 generates a model-to-model transformation from the formatting instructions and executes the same using the previously determined abstract annotations. FIG. 8 illustrates an example of a model-based reporting model annotations metamodel, which can be a target metamodel of the transformation. In this metamodel, the AnnotationElement constitutes a new graphical element for the model-based reporting by the MbR frontend. It can include the annotation content with styles as well as styles for the element itself. These styles (i.e., ElementStyle and ContentStyle) are depicted in FIG. 9, which illustrates an example of a formatting metamodel. The formatting metamodel, like the reporting data metamodel, can be customized and extended. To do so, the MbR Frontend 102 can determine the consideration and processing of the style for the MbR.

For model-based reporting, the MbR Frontend 102 can issue a service call to the MbR Backend Service 104 passing an MbR DSL Script 106 and display the reporting data in graphical DSLs. To do so, the MbR Frontend 102 can process the results from the service call in the form of a formatting model and apply the processed results to the model. The MbR Frontend 102 can serve as the reporting tool for users of business applications. In addition, the MbR Frontend 102 can be used as an end-to-end monitor and to bridge a gap between business application execution and design if integrated into or realized within the integrated development environment (IDE) of developers.

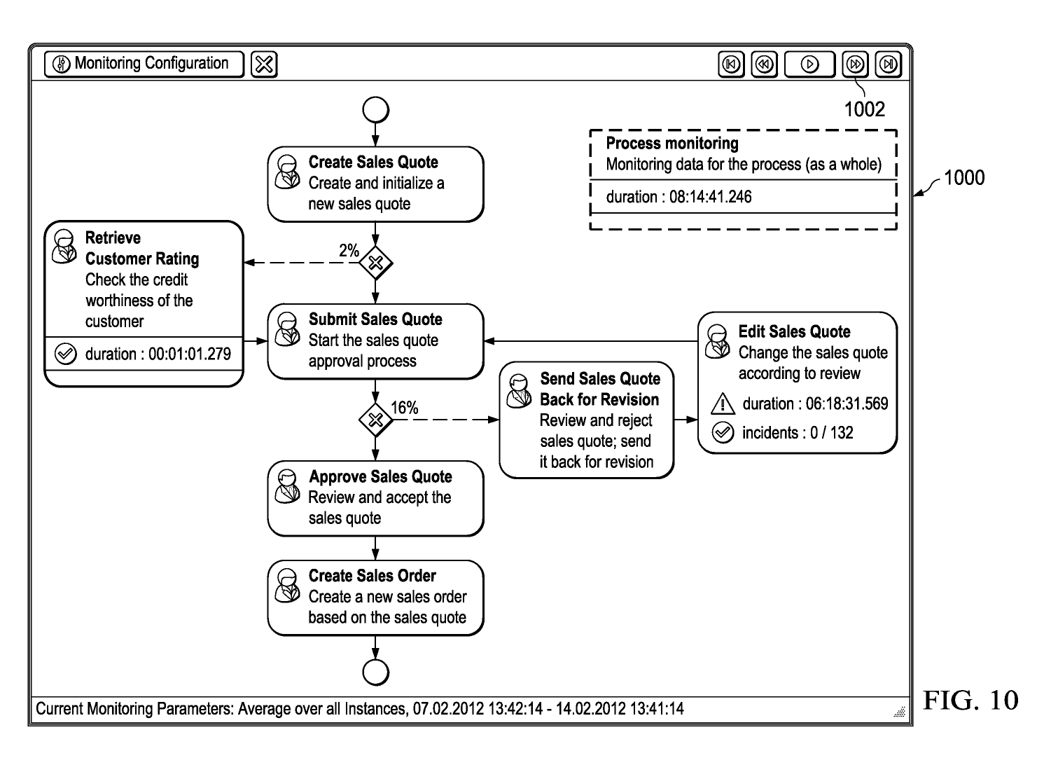

The MbR approach described in this disclosure can be applied to different domains and models such as use case, architectural, and class diagrams. In some implementations, MbR can be applied for process monitoring which is a domain from business process management (BPM). Using a Quotation Creation process from the sales and distribution domain, an implementation of using a MbR script for specifying the reporting is described. The MbR results are shown as data and within a monitoring prototype as MbR frontend (FIG. 10).

In this example, a customer request for a quotation is received. A sales clerk initiates a process when creating a sales quote. After submission, the quote is either approved or reviewed and revised. When the sales quote has been approved, a corresponding sales order is created and sent to the customer. For facilitating the approval process, a customer rating service can recommend details of the sales quote such as discounts or prepayments. As the external business service for the customer rating might occasion expenditures per usage, it may not invoked by default by the process. The process is provided from an enterprise resource planning (ERP) system that—during execution—supplies business intelligence with traceability information. The resulting reporting data is stored in a data warehouse according to the metamodels for reporting and context data as shown in FIGS. 5 and 6.

In the scenario, the MbR user (for example, a stakeholder that specifies and consumes the model-based reporting) is interested (1) in how often the customer rating is advised and revisions take place, (2) in how long it takes for the ratings, the revisions, and the overall process to complete, and (3) if there are incidents in the Edit Sales Quote activity due to compliance violations of separation of duties (SoD) regulations (i.e., a sales clerk may not edit the sales quote).

An MbR DSL instance can be defined to answer the user's questions. An example syntax of the MbR reporting DSL is shown below:

| | |
|---|---|
| 1 | # Model Selection (1st part) |
| 2 | m: Order2Cash |
| 3 | |
| 4 | # Instance Selection (2nd part) |
| 5 | b: m.start >= “2012-02-07 13:42:14” |
| 6 | & m.end < “2012-02-14 13:42:14” |
| 7 | |
| 8 | # Abstract Annotation (3rd part) |
| 9 | m << duration = AVG(b.duration) |
| 10 | |
| 11 | 557dbb5d-7558-4f8e-acc6-d618f12487a6 |
| 12 | b3b6e8e5-3b30-44a3-8dd5-29f354c60877 |
| 13 | << rate = COUNT(b.visit)/COUNT(b*) |
| 14 | |
| 15 | 8ee48a10-01f0-49a3-b4f5-e13acb5829c5 |
| 16 | << durRCR = AVG(b.duration) |
| 17 | |
| 18 | f35837fa-7fcc-4fc4-9e2a-ac2ddbd696ed |
| 19 | << durESQ = AVG(b.duration) |
| 20 | << incidents = COUNT(b.violation) |
| 21 | + “ / ” + COUNT(b*) |
| 22 | |
| 23 | # Presentation Instructions (4th part) |
| 24 | duration >> Rectangle { |
| 25 | display: absolute; x: 465; y: 60; |
| 26 | background: lightgray; |
| 27 | gradient: left2right; |
| 28 | gradient-color: white; |
| 29 | dashstyle: dash; |
| 30 | }{ } |
| 31 | rate >> Edge { |
| 32 | display: relative; y: −15; |
| 33 | }{ |
| 34 | color: rgb($,$,$); |
| 35 | dashstyle: $ < 50 ? |
| 36 | rgb(128,128,128) : rgb(255,255,255) |
| 37 | } |
| 38 | durRCR(“duration”) >> Comment { |
| 39 | display: inline; |
| 40 | background: #b0c4de; |
| 41 | gradient: left2right; |
| 42 | gradient-color: white; |
| 43 | }{ |
| 44 | display-compliance: true; |
| 45 | } |
| 46 | durESQ(“duration”),incidents >> Comment { |
| 47 | display: inline; |
| 48 | }{ |
| 49 | display-compliance: true; |
| 50 | } |

In the example DSL script shown in the listing above, the Quote2Order process model is chosen for the MbR (Line 2). Then, a set of instances is selected; each instance has a respective start and end timestamp (Lines 5-6). Next, some abstract annotations are defined such as an annotation for the process model with the average duration of the process instances (Line 9). Two model elements that correspond to sequence flows are identified by UUIDs and are annotated with the usage in percent (Lines 11-13). Note that instance sets in evaluation expressions of abstract annotations are reduced for each model element to actual corresponding execution points by default. For example, in the first annotation, the average duration is calculated for the process. Thus, by convention a model element context is used in queries. Using an asterisk (*) it is possible to use the entire instance set. In the second annotation, thus, the usage rate is calculated by dividing the visit counts by the total number of instances. In the third annotation (Lines 15-16) the same evaluation expression is used as in the first annotation, yet with the customer rating service selected it relates to a different model element. The last example (Lines 18-21) defines multiple annotations for the Edit Sales Quote activity.

Finally, the formatting instructions are declared for the abstract annotations. For this the annotation keys are used and it is specified which AnnotationElement from the model-annotation metamodel shown in FIG. 8 shall be created. In the first (resp. second) block defined by curly brackets ElementStyles (resp. ContentStyles) can be specified according to the formatting metamodel shown in FIG. 9. For simplicity, it is possible to create model-annotations (i.e., AnnotationElements) with equal styles for different annotations as shown in the last example (Lines 46-50). It also explicitly sets the name of the durESQ annotation key which name otherwise is used by default. Using a sigil ($), it is possible to make the value of style properties dependent on the annotation. For the rate annotation (Lines 31-37) the color and dashstyle properties are dependent on the value of the according usage. As multiple model elements were selected also multiple model-annotations are created. That is, each model element (of an abstract-annotation) is annotated.

Invoked with the MbR script, the MbR service returns annotations for model-based reports in the form of an annotation model (conforming to the metamodel shown in FIG. 8). That is, the script is interpreted and the MbR runtime is executed while reporting data for the model elements is resolved using the correlation entries. The listing below is an example of model annotations for the MbR Frontend 102 and partially displays the results for the MbR script:

| | |
|---|---|
| 1 | <ModelAnnotations> |
| 2 | <annotationElements |
| 3 | xsi:type=“modelAnnotations:Comment” |
| 4 | modelID=“557dbb5d-7558-4f8e-acc6-d618f12487a6”> |
| 5 | <styles xsi:type=“presentation:PositionStyle” |
| 6 | display=“relative” y=“−15”/> |
| 7 | <styles xsi:type=“presentation:ColorStyle” |
| 8 | color=“#888888”/> |
| 9 | <styles xsi:type=“presentation:LineStyle” |
| 10 | dashstyle=“dot”/> |
| 11 | <contents xsi:type=“annotationContent:Metric” |
| 12 | value=“2” unit=“Percent”/> |
| 13 | </annotationElements> |
| 14 | <annotationElements |
| 15 | xsi:type=“modelAnnotations:Comment” |
| 16 | modelID=“f35837fa-7fcc-4fc4-9e2a- |
| | ac2ddbd696ed”> |
| 17 | <styles xsi:type=“presentation:PositionStyle” |
| 18 | display=“inline”/> |
| 19 | <contents |
| 20 | xsi:type=“annotationContent:KeyValuePair” |
| 21 | complianceLevel=“warning” key=“duration”> |
| 22 | <value xsi:type=“annotationContent:Metric” |
| 23 | value=“06:18:31.569” unit=“Time”/> |
| 24 | </contents> |
| 25 | <contents xsi:type=“annotationContent:Text” |
| 26 | complianceLevel=“ok” value=“0 / 132”/> |
| 27 | </annotationElements> |
| 28 | <!-- ... //--> |
| 29 | </ModelAnnotations> |

Finally, Extensible Markup Language [14] (XML) serialized code is processed by the MbR Frontend 102 that creates annotations for the AnnotationElements using the contained styles and contents. That is, the MbR results are woven into the process model and displayed accordingly.

FIG. 10 illustrates an example of a model-based report that displays model-annotations in a process model. The model-based report is displayed with the resulting process diagram in a monitoring prototype. Icons indicate and thus report the compliance level. For the Edit Sales Quote a warning is displayed for the duration, as it is beyond a certain threshold as specified in a requirement.

The afore-described implementations for model-based reporting implement models. However, the approach does not presume business applications to be model-driven. In some implementations, MbR can be applied to non-model-driven systems such as legacy systems. To do so, a graphical DSL reflecting the concepts in a user-tailored way can be specified. The underlying model (i.e., abstract DSL) can be used as a first step towards MDE. Because model-based reporting need not be limited to a particular model it is applicable to different types of models such as process models, architectural diagrams, graphical user interface (GUI) models, data models, or combinations of them. Having multiple models that reflect systems, it is possible to have different views on the system.

As described above, in some implementations, business applications can disclose traceability information. Alternatively, or in addition, business analytic applications can populate the reporting data in the data warehouse according to the reporting data metamodel. If the latter is not the case, reporting data needs to be transformed accordingly. The afore-described techniques can be implemented for mashups, i.e., for combining data from various sources. To do so, mashups can be realized on top of MbR. Finally, the MbR approach can be applicable to online analytical processing (OLAP) functionality, and supporting capabilities such as drill-down and navigability.

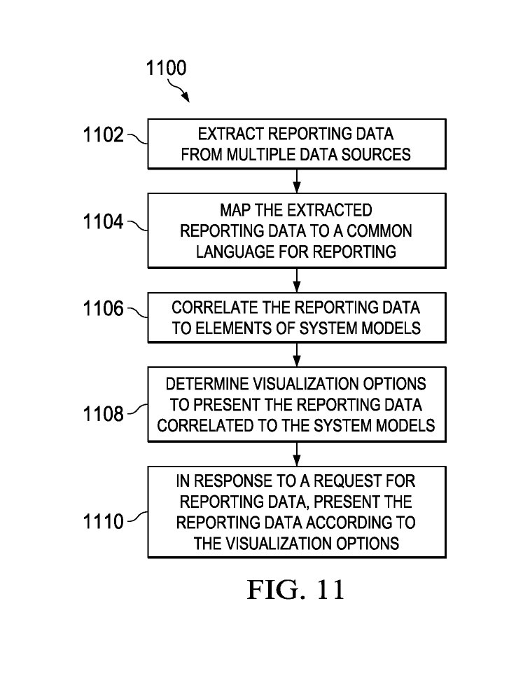

FIG. 11 is a flowchart of a process 1100 for visualizing reporting data using system models. The process 1100 can be implemented as computer program instructions stored on a computer-readable medium and executed by data processing apparatus. For example, the process 1100 can be implemented by the system 100. At 1102, reporting data can be extracted from multiple data sources. Each data source can be configured to store at least a portion of the reporting data. At 1104, the extracted reporting data can be mapped to a common language for reporting. At 1106, the reporting data can be correlated to elements of system models. At 1108, visualization options to present the reporting data correlated to the system models can be determined. At 1110, the reporting data can be presented according to the visualization options in response to receiving a request for reporting data.

Model-based reporting described here establishes and enables end-to-end solutions, for example, for the monitoring of business applications. The approach described here illustrates the feasibility and exemplifies the MbR idea with an architecture, utilizing a modeling approach. Additional features that can be implemented with and incorporated into the MbR approach include the establishment and management of the correlation entries and the DSL for expressing the model selection, annotation, and formatting. The features can also include traceability that includes model annotation, business process monitoring, and reporting. MDE provides opportunities such as trace generation and trace analysis, for example, by establishing a standard traceability metamodel and identifying artifacts across space and time.

Because the MbR approach is agnostic about a concrete traceability metamodel, it can build on the unique identification which is given when adopting UUIDs to implement traceability. For example, traceability links can be established through trace generation. For MbR these traces can also be registered. During runtime traceability dependencies can be identified automatically through trace analysis. Independent from a specific domain (and model), trace analysis for model elements can be applied for creating and maintaining correlation entries in the data warehouse. Suppose a trace analysis would take the role of providing the correlation service in MbR, an end-user would be directly presented with the results. In this case an advanced user could give feedback on false positives or negatives to the trace analyzer and even provide traceability dependencies manually. Thus, the MbR approach can be combined with research results from trace generation and analysis.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium, for example, the computer-readable medium, can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical and/or non-transitory components or media (e.g., multiple CDs, disks, or other storage devices).

The operations described in this specification can be implemented as operations performed by a data processing apparatus, for example, data processing apparatus 108, on data stored on one or more computer-readable storage devices or received from other sources. The subject matter described here can be implemented in a cloud computing environment. For example, the requests from client devices to form associations with the central entity can be received over a cloud to which the client devices and the central entity are connected. In addition, the requests, the user data, and data generated by the central entity can be stored in the cloud.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such back-end, middleware, or frontend components. The components of the system can be interconnected by any form or medium of digital data communication, e.g., a communication network, for example, network 126. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any implementations or of what may be claimed, but rather as descriptions of features specific to particular implementations of particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by data processing apparatus to visualize reporting data using system models, the method comprising:
extracting reporting data from a plurality of data sources, each data source configured to store at least a portion of the reporting data;
mapping the extracted reporting data to a common language for reporting;
correlating the mapped reporting data to elements of system models;
identifying visualization options to present the mapped reporting data correlated to the system models; and
presenting the mapped reporting data according to the visualization options in response to receiving a request for reporting data.

2. The method of claim 1, wherein presenting the mapped reporting data according to the visualization options comprises:
creating annotations using contained styles and content;
including the created annotations in a process system model; and
displaying the annotations in a user interface of a display device.

3. The method of claim 1, wherein correlating the mapped reporting data to elements of system models results provides abstract annotations of the elements of the system models, and wherein the method further comprises transforming the abstract annotations into concrete model annotations.

4. The method of claim 1, wherein the common language is a domain-specific language that is executable to select runtime information from execution instances, combine the selected runtime information with a model for model-based reporting, and specify a visualization of the model-based reporting.

5. The method of claim 4, wherein the domain-specific language includes a model selection part to select a model for the model-based reporting, an instance selection part for selecting instances of runtime executions, an abstract annotation part to assign reporting data to elements of system models, and a formatting part to display the mapped reporting data graphically.

6. The method of claim 1, wherein correlating the mapped reporting data to elements of system models comprises generating a plurality of execution points that correspond to a plurality of elements of system models, wherein each execution point is uniquely identifiable.

7. The method of claim 1, wherein the mapped reporting data includes data produced by a business application through at least one of events or stored log messages, and wherein the mapped reporting data is processed by business analytics.

8. The method of claim 7, wherein extracting the mapped reporting data comprises monitoring the mapped reporting data either online through events or offline through log messages.

9. A non-transitory computer-readable medium storing computer instructions executable by data processing apparatus to perform operations comprising:
extracting reporting data from a plurality of data sources, each data source configured to store at least a portion of the reporting data;
mapping the extracted reporting data to a common language for reporting;
correlating the mapped reporting data to elements of system models;
identifying visualization options to present the mapped reporting data correlated to the system models; and
presenting the mapped reporting data according to the visualization options in response to receiving a request for reporting data.

10. The medium of claim 9, wherein presenting the mapped reporting data according to the visualization options comprises:
creating annotations using contained styles and content;
including the created annotations in a process system model; and
displaying the annotations in a user interface of a display device.

11. The medium of claim 9, wherein correlating the mapped reporting data to elements of system models results provides abstract annotations of the elements of the system models, and wherein the operations further comprise transforming the abstract annotations into concrete model annotations.

12. The medium of claim 9, wherein the common language is a domain-specific language that is executable to select runtime information from execution instances, combine the selected runtime information with a model for model-based reporting, and specify a visualization of the model-based reporting.

13. The medium of claim 12, wherein the domain-specific language includes a model selection part to select a model for the model-based reporting, an instance selection part for selecting instances of runtime executions, an abstract annotation part to assign reporting data to elements of system models, and a formatting part to display the mapped reporting data graphically.

14. The medium of claim 9, wherein correlating the mapped reporting data to elements of system models comprises generating a plurality of execution points that correspond to a plurality of elements of system models, wherein each execution point is uniquely identifiable.

15. The medium of claim 9, wherein the mapped reporting data includes data produced by a business application through at least one of events or stored log messages, and wherein the mapped reporting data is processed by business analytics.

16. The medium of claim 15, wherein extracting the mapped reporting data comprises monitoring the reporting data either online through events or offline through log messages.

17. A system comprising:
data processing apparatus; and
a computer-readable medium storing computer instructions executable by data processing apparatus to perform operations comprising:
extracting reporting data from a plurality of data sources, each data source configured to store at least a portion of the reporting data;
mapping the extracted reporting data to a common language for reporting;
correlating the mapped reporting data to elements of system models;
identifying visualization options to present the mapped reporting data correlated to the system models; and
presenting the mapped reporting data according to the visualization options in response to receiving a request for reporting data.

18. The system of claim 17, wherein presenting the mapped reporting data according to the visualization options comprises:
creating annotations using contained styles and content;
including the created annotations in a process system model; and
displaying the annotations in a user interface of a display device.

19. The system of claim 17, wherein correlating the mapped reporting data to elements of system models results provides abstract annotations of the elements of the system models, and wherein the operations further comprise transforming the abstract annotations into concrete model annotations.

20. The system of claim 17, wherein the common language is a domain-specific language that is executable to select runtime information from execution instances, combine the selected runtime information with a model for model-based reporting, and specify a visualization of the model-based reporting.

21. The system of claim 20, wherein the domain-specific language includes a model selection part to select a model for the model-based reporting, an instance selection part for selecting instances of runtime executions, an abstract annotation part to assign reporting data to elements of system models, and a formatting part to display the mapped reporting data graphically.

22. The system of claim 17, wherein correlating the mapped reporting data to elements of system models comprises generating a plurality of execution points that correspond to a plurality of elements of system models, wherein each execution point is uniquely identifiable.

23. The system of claim 17, wherein the mapped reporting data includes data produced by a business application through at least one of events or stored in log messages, and wherein the mapped reporting data is processed by business analytics.

24. The system of claim 23, wherein extracting the mapped reporting data comprises monitoring the mapped reporting data either online through events or offline through log messages.
